(19) United States
(12) Patent Application Publication
(10) Pub. No.: US 2011/0006993 A1
(43) Pub. Date: Jan. 13, 2011

(54) METHOD OF FABRICATING A GLASS WITH CAPACITIVE TOUCH KEYS FOR AN ELECTRONIC INSTRUMENT AND INSTRUMENT COMPRISING THE SAME

(75) Inventor: Giovanni LONGA, Neuchatel (CH)

Correspondence Address: GRIFFIN & SZIPL, PC, SUITE PH-1, 2300 NINTH STREET, SOUTH, ARLINGTON, VA, 22204, US

(73) Assignee: EM MICROELECTRONIC-MARIN SA, Marin (CH)

(21) Appl. No.: 12/834,783

(22) Filed: Jul. 12, 2010

(30) Foreign Application Priority Data
Jul. 10, 2009 (EP) 09165225.5

(51) Int. Cl. G06F 3/02; B29C 41/02

(52) U.S. Cl. 345/169; 264/104

(57) ABSTRACT

The method is for fabricating a transparent or semi-transparent element, such as a glass (1), with capacitive touch keys, for a portable electronic instrument. This method includes the steps of placing an insulating film (3), on which are formed electrodes (2), acting as capacitive touch keys, conductive paths (4), each connected to a respective electrode, and external contact terminals (6), each connected via the conductive paths to the corresponding electrodes, in a transparent or semi-transparent plastic substance (5) in liquid form inside a mould. This liquid substance is then solidified inside the mould, to coat at least part of the film that includes the electrodes, the conductive paths and at least part of the external contact terminals of said film. Upon removal from the mould, a glass is obtained with capacitive touch keys integrated within said solidified plastic substance of the glass.

This application claims priority from European Patent Application No. 09165225.5 filed Jul. 10, 2009, the entire disclosure of which is incorporated herein by reference.

### FIELD OF THE INVENTION

The invention concerns a method of fabricating a transparent or semi-transparent element, such as a glass, with capacitive touch keys, for an electronic instrument. The glass includes, in particular, an insulating film on which are formed electrodes, contact terminals and conductive paths, which respectively connect each electrode to a corresponding contact terminal.

The invention also concerns an electronic instrument, which includes a transparent or semi-transparent element, such as a glass with capacitive touch keys, obtained via the fabrication method.

“Electronic instrument” means any portable device, such as a wristwatch, mobile telephone, badge or other apparatus, which has a screen or dial for displaying data, above which there is a glass that closes the instrument case.

### BACKGROUND OF THE INVENTION

Making a glass with one or a number of transparent electrodes as capacitive touch keys to be fitted to an electronic instrument is well known, particularly within the field of horology or mobile telephones. EP Patent No. 0 674 247 can be cited in this regard. This Patent discloses a watch with a manual control device. Said described watch includes a metal case forming earth, a glass and the manual control device including at least one electrode, used as a capacitive touch key and placed on the inner surface of the glass. This capacitive touch key can be considered activated in conjunction with a processing circuit in the watch, via the watch user's finger, placed opposite the electrode on the external surface of the glass. This allows a total capacitance to be formed between the finger and the electrode, and between the electrode and earth, formed by the metal watch case. The processing circuit in the watch also includes a voltage-frequency converter, whose oscillation frequency is determined by the value of the aforementioned capacitance. The transparent electrode is thus connected in a well known manner via a conductor to the converter, which is housed in the case.

Usually a number of transparent electrodes, which form capacitive touch keys, are arranged on the inner surface of the glass of the electronic instrument, such as a wristwatch. The capacitive touch keyboard thereby formed may be used to replace the usual external control means, such as push-buttons, used for controlling the various functions of an electronic instrument. These transparent electrodes are made on the inner surface of the glass by depositing a conductive oxide layer, which may conventionally be an indium and tin oxide (ITO), and by chemically etching said conductive oxide layer. The conductive oxide layer is deposited by evaporation over a thickness generally comprised between 25 and 75 nm, and preferably between 45 and 55 nm. Each transparent electrode is connected by a conductive path as far as a contact zone on the edge of the electronic instrument glass for connection, via a connector, to the processing circuit inside the electronic instrument.

In other embodiments of the electronic instrument with a capacitive touch key glass, the instrument case, and the glass or crystal, may be made of plastic material. The plastic glass, particularly for an electronic instrument, such as a wristwatch, must be of sufficient thickness, on the one hand, in order to resist shocks from external agents and, on the other hand, to withstand a certain level of hydrostatic pressure when the watch is immersed. The glass must be able to withstand pressure of up to around 3 bars. This large thickness of the glass can thus be detrimental to the proper working of the capacitive touch keyboard arranged on the inner surface of the glass. Indeed, a thick glass leads to a significant dielectric inserted between the electrodes of the capacitive touch keys and the user's finger, placed opposite at least one of the electrodes to be activated, which is generally a drawback for such capacitive touch glasses.

EP Patent No. 1 544 178, which discloses a method of fabricating transparent electrodes for a tactile screen, may also be cited. A conductive array of an ITO oxide layer is formed on an inner surface of a transparent substrate that forms, for example, a watch glass. This conductive array includes the transparent electrodes and conductive paths, which connect respectively the electrodes to a contact zone at the edge of the substrate. This structured conductive oxide layer is further coated with two layers of dielectric with different refractive index in order to make the electrodes invisible. However, as previously described, the transparent substrate generally has to be very thick. This is detrimental to the proper working of the capacitive touch keys formed on the inner surface of the substrate, in conjunction with an electronic instrument processing circuit, which is a drawback.

In the case of a watch with a digital time display, capacitive touch keys can be made in the liquid crystal display device. However, since this type of watch case is closed by another glass in addition to the liquid crystal display device, a relatively large distance remains between the user's finger, placed on the external surface of the glass, and the electrode of any capacitive touch key to be activated. This also constitutes a drawback.

### SUMMARY OF THE INVENTION

It is thus an object of the invention to overcome the drawbacks of the prior art by providing a method of fabricating a glass with capacitive touch keys for a portable electronic instrument, which is sufficiently resistant, yet guarantees a high level of operating sensitivity for the capacitive touch keys, activated in particular by a user's finger.

The invention therefore concerns a method of fabricating a transparent or semi-transparent element, with capacitive touch keys for a portable electronic instrument, wherein it includes steps consisting in:
placing an insulating film, on which are formed transparent electrodes forming capacitive touch keys, transparent conductive paths, each connected to a respective electrode, and external contact terminals, each connected via the conductive paths to the corresponding transparent electrodes, in a transparent or semi-transparent plastic substance in liquid form inside a mould, and
solidifying, inside the mould, the liquid plastic substance, which coats at least part of the film that includes the electrodes, the conductive paths and at least part of the external contact terminals of said film, so as to obtain the transparent or semi-transparent element with capacitive touch keys integrated within said solidified plastic substance of the transparent or semi-transparent element, to improve the sensitivity of the integrated capacitive touch keys, which is inversely proportional to the distance between the electrodes and the contact surface of the transparent or semi-transparent element.

Particular steps of the fabricating method are defined in the dependent claims 2 to 11.

One advantage of the method of fabricating a transparent or semi-transparent element with capacitive touch keys according to the invention lies in the fact that the electrodes of the capacitive touch keys are moulded into the material forming the transparent or semi-transparent element of the electronic instrument. Even if the transparent or semi-transparent element is relatively thick, in order to resist shocks from external agents and to withstand a certain level of hydrostatic pressure, a high level of sensitivity is guaranteed for the capacitive touch keys. In order to achieve this, the electrodes made on a transparent insulating film can be located, for example, at mid-height in the thickness of the glass after the moulding operation. This improves the sensitivity of the capacitive touch keys integrated in the glass compared to capacitive touch glasses of the prior art, since sensitivity is inversely proportional to the distance between the electrodes and the contact surface of the glass.

The invention therefore also concerns an electronic instrument, such as a wristwatch, which includes a glass with capacitive touch keys obtained via the fabricating method.

### BRIEF DESCRIPTION OF THE DRAWINGS

The objects, advantages and features of the method of fabricating a glass with capacitive touch keys for a portable electronic instrument, and the instrument including the same will appear more clearly in the following description, based on non-limiting embodiments, illustrated by the drawings, in which:

FIGS. 1a and 1b show a top view and cross-section along I-I of FIG. 1a of a first embodiment of the capacitive touch glass obtained via the fabricating method according to the invention,

FIG. 2 shows a cross-section along I-I of FIG. 1a of a second embodiment of the capacitive touch glass obtained via the fabricating method according to the invention,

FIG. 3 shows a cross-section along I-I of FIG. 1a of a third embodiment of the capacitive touch glass obtained via the fabricating method according to the invention,

FIG. 4 shows a cross-section along I-I of FIG. 1a of a fourth embodiment of the capacitive touch glass obtained via the fabricating method according to the invention,

FIG. 5 shows a cross-section along I-I of FIG. 1a of a fifth embodiment of the capacitive touch glass obtained via the fabricating method according to the invention, and

FIG. 6 shows a partial cross-section of a watch that includes a capacitive touch glass according to the second embodiment of the invention.

### DETAILED DESCRIPTION OF THE INVENTION

In the following description, all those elements forming the capacitive touch glass for a portable electronic instrument that are well known to those skilled in this technical field are only recounted in a simplified manner. Reference is made mainly to a capacitive touch glass to be fitted to a wristwatch as the portable electronic instrument. However, this type of capacitive touch glass can also be fabricated for use in various other electronic instruments.

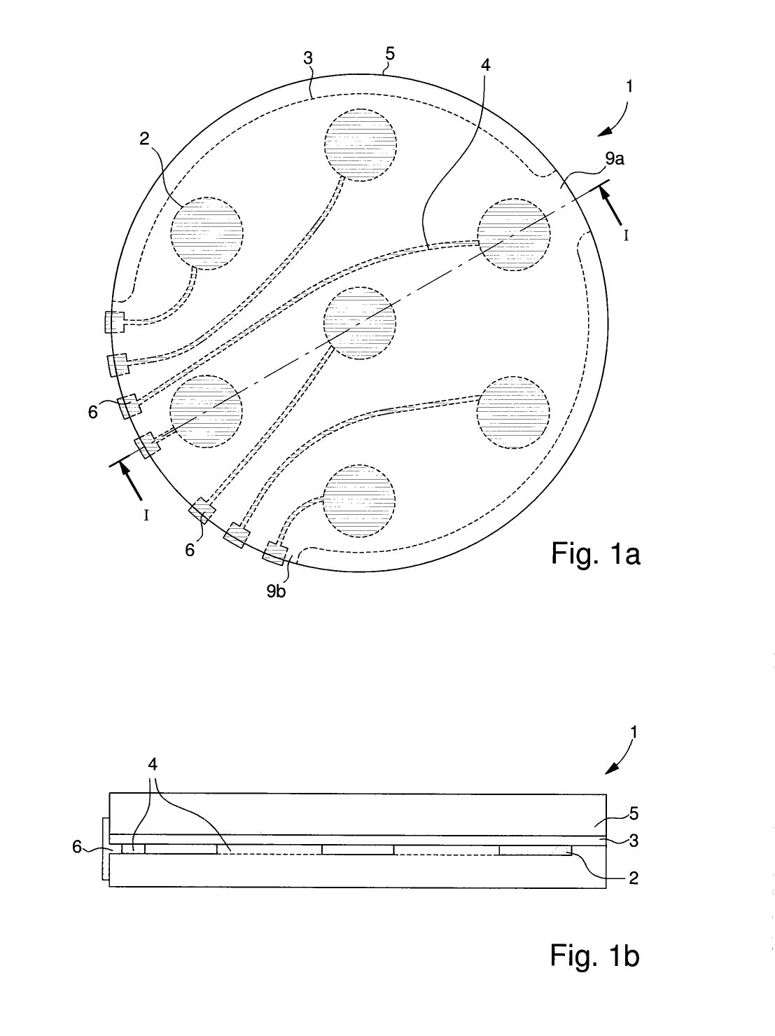

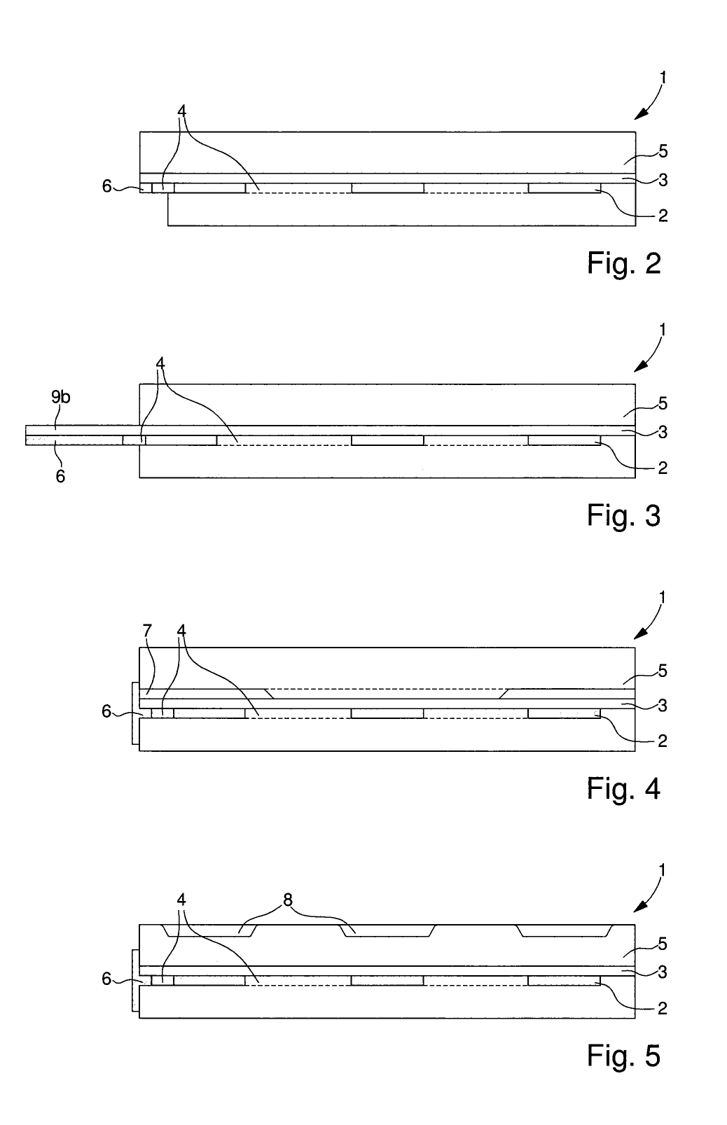

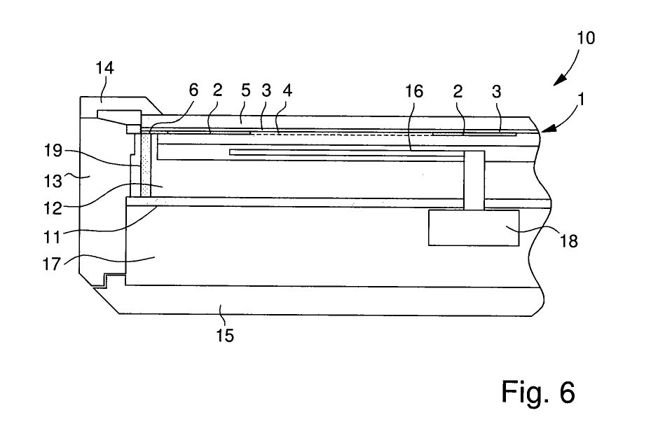

FIGS. 1a and 1b show a top view and a diametral cross-section of a first embodiment of a transparent or semi-transparent element with capacitive touch keys which can be a capacitive touch glass obtained via the fabricating method according to the invention. Glass 1 may be of circular shape as shown in FIG. 1a, but could also be rectangular or of a different shape. Its shape may be generally flat as shown in FIG. 1b, but also convex (not shown). This capacitive touch glass can be fabricated in particular for a wristwatch type watch, discussed below with reference to FIG. 6. In FIGS. 1a and 1b and in FIGS. 2 to 6, the various contrasts and thicknesses of the elements shown have been exaggerated slightly for the purpose of improving comprehension of the invention.

Glass 1 includes, first of all, an insulating film 3 on which transparent electrodes 2, transparent conductive paths 4 and external contact terminals 6 of a contact zone are formed. Each transparent electrode 2 is connected, via a respective conductive path 4, to a contact terminal 6 of the transparent contact zone. Contact zone 6 is preferably at the edge of glass 1.

Electrodes 2, conductive paths 4 and contact terminals 6 are obtained in a well known manner following a chemical etch of a conductive layer of indium and tin oxide (ITO) deposited beforehand on the insulating film. The thickness of this ITO layer may be between 25 and 75 nm and preferably between 45 and 55 nm. The thickness of the insulating film can be equivalent to that of the ITO layer.

As shown in FIG. 1a, transparent electrodes 2, which act as capacitive touch keys, are seven in number and sufficiently spaced apart from each other to allow a single capacitive touch key to be activated by a finger placed on the external contact surface of the glass. Of course, one could envisage making a larger or more restricted number of touch keys in glass 1 depending upon the electronic instrument that contains the glass, in order to perform specific desired functions. Said transparent electrodes 2 may also be of various other shapes than that shown in FIG. 1a, and arranged at the periphery of the glass or over the entire inner surface of glass 1.

Once the transparent electrode film 2, including conductive paths 4 and contact zones 6, has been made, the film is arranged in a mould (not shown) for a watch glass moulding operation. The inner shape of the mould generally matches the shape of the glass to be obtained. Film 3 can include portions 9a and 9b, which are initially of a longer determined length than those shown in FIG. 1a, so as to hold electrode film 2 inside the mould. The two portions 9a and 9b are, for example, clamped, closing the two parts that form said mould.

After the mould has been closed and film 3 with transparent electrodes 2 is being held inside the mould, a plastic substance, heated in liquid form, is introduced through at least one aperture in the mould so as to fill it and coat one part of the electrode film. The plastic substance is then solidified and the glass thereby obtained is removed from the mould. A trimming operation is then performed to finish the final shape of the glass. Finally, the two portions 9a and 9b are cut flush with the edge of the glass 1 thereby obtained, allowing the possibility of connecting external contact terminals 6 directly onto the lateral surface of glass 1.

Complementary conductive connection portions can also be made at the level of contact zone 6 over one part of the lateral surface of the glass. This facilitates the connection of transparent electrodes 2, via an electric connector, to a processing circuit inside the electronic instrument. The external contact terminals 6 of the contact zone can also be made of a material other than ITO oxide, for example, metal. This allows complementary conductive portions also to be made in a metallic material, which facilitates connection via the electric connector.

During the moulding operation, one could also envisage injecting a plastic substance, or even another transparent material into the mould, in powder form, and then heating said mould to make said substance liquid, and coating electrode film 3. One could also envisage first of all placing the insulating film with transparent electrodes 2 in a liquid plastic bath and then enclosing the film in the mould dipped in the liquid plastic substance. Finally, the liquid substance coating the film is solidified in the mould and the finished glass is removed from the mould.

For this embodiment of the watch glass with integrated capacitive touch keys, an in-mould decoration technique (IMD) could be used, or a film insert moulding (FIM) technique or other techniques. In the FIM technique, film 3 with transparent electrodes 2 can be integrated in the liquid substance prior to solidification.

FIG. 2 shows a diametral cross-section of a second embodiment of capacitive touch glass 1 obtained via the fabricating method according to the invention, for an electronic instrument. It is to be noted that all those elements of glass 1 which are described in FIG. 2 bear identical reference signs to those shown in FIGS. 1a and 1b. Consequently, for the sake of simplification, the description of each of these same elements will not be repeated.

The only difference in this second embodiment of the capacitive touch glass lies in the fact that, after the moulding operation, upon removal from the mould, the solidified plastic substance forming the glass does not cover at least one bottom surface of external contact terminals 6 and part of conductive paths 4. This means that external contact terminals 6 can be directly connected to an electric connector.

We could also have envisaged performing a film moulding operation as in the first embodiment, then performing a milling operation from the edge of the glass on the side of contact zone 6. Milling a bottom part of material 5 that forms the watch glass uncovers external contact terminals 6 of the contact zone and a portion of conductive paths 4 from beneath. Because of this milling operation, it is possible to connect the contact zone directly to an electric connector linked to the electronic instrument processing circuit as shown in FIG. 6, which is explained below.

FIG. 3 shows a diametral cross-section of a third embodiment of capacitive touch glass 1 obtained via the fabricating method according to the invention, for an electronic instrument. It is to be noted that all those elements of glass 1 that are described in FIG. 3 bear the same reference signs as those shown in FIGS. 1a, 1b and 2. Consequently, for the sake of simplification, the description of each of these elements will not be repeated.

External contact terminals 6 are on one of the two portions 9a and 9b of the film, which are clamped in the mould for the moulding operation. One can thus envisage keeping the entire contact zone 6 and part of conductive paths 4 on the side of portion 9b clamped by the two parts of the mould in the closed position. This provides a glass, which, upon removal from the mould, includes part of the flexible insulating film with uncovered contact terminals 6 opening onto the lateral surface of glass 1. This part of the film, which is not shown, can be used immediately for a cable connection.

Contact terminals 6 can be made via a technique of silk screen printing a paste that has metal particles on insulating film 3. This may be a paste made of silver, graphite or another material.

FIG. 4 shows a diametral cross-section of a fourth embodiment of capacitive touch glass 1, obtained via the fabricating method according to the invention, for an electronic instrument. It is to be noted that all those elements of glass 1 that are described in FIG. 4 bear the same reference signs as those shown in FIGS. 1a, 1b, 2 and 3. Consequently, for the sake of simplification, the description of each of these same elements will not be repeated.

In this fourth embodiment of the capacitive touch glass, a decorative layer 7 is made above the film and partly above transparent electrodes 2. When glass 1 is fitted to an electronic instrument, this decorative layer 7, which may be opaque or semi-transparent, can conceal contact zone 6 from the sight of a user of the instrument.

Decorative layer 7 can be made on insulating film 3 prior to or after the conductive ITO oxide layer is structured by a chemical etch. Once the conductive layer has been structured and the decorative layer is made on the film, the operation for moulding glass 1 can be performed in a mould provided for this purpose, as indicated above with reference to FIG. 1b. The liquid plastic substance coats film 3 and the substance is solidified in the mould so that the glass thereby obtained has the electrode film and the decorative layer integrated within the solid transparent plastic substance of glass 1.

As with the case of the first embodiment of the glass of FIG. 1b, complementary connection conductive portions can be made at the level of contact zone 6 over part of the trimmed lateral surface of the glass. These conductive portions facilitate connection of transparent electrodes 2 via an electric connector, to a processing circuit inside the electronic instrument. However, one could also envisage the inner surface of the mould being configured such that at least contact terminals 6 are not coated by the solidified plastic substance upon removal from the mould, as in the second embodiment. One could also envisage one part of flexible film 3 opening out of the lateral surface of the glass with contact terminals 6 immediately accessible over portion 9b of the film, as in the third embodiment.

It is to be noted that one or a number of decorative layers 7 can be deposited on insulating film 3. The decorative layer(s) can bear numbered indications or symbols or at least one image. Moreover, this decorative layer 7 can also be applied to the second embodiment of capacitive touch glass 1 shown in FIG. 2. This conceals the contact zone well and its connection to a Zebra type connector of the electronic instrument containing the glass.

FIG. 5 shows a diametral cross-section of a fifth embodiment of capacitive touch glass 1, obtained via the fabricating method according to the invention, for an electronic instrument such as a wristwatch. It is to be noted that all those same elements of glass 1 that are described in FIG. 5 bear the same reference signs as those shown in FIGS. 1a, 1b, 2, 3 and 4. Consequently, for the sake of simplification, the description of each of these same elements will not be repeated.

This fifth embodiment of the glass is very similar to the first embodiment of the glass of FIG. 1b. The only difference is that thinned portions 8 are made in the thickness of the glass from a surface for contact with a user's finger, solely above transparent electrodes 2. These thinned portions 8, the number of which may be the same as the number of electrodes, locally reduce the distance between each transparent electrode and the finger in contact with the glass in each thinned portion 8. This improves the operating sensitivity of the capacitive touch keys via this local reduction in thickness, yet the glass maintains a good general resistance to various external stresses. Because of these thinned portions 8 in the thickness of the glass, we could envisage reducing the surface of each electrode while still maintaining the same level of sensitivity as in the other embodiments described above.

Thinned portions 8 in the thickness of the glass can be made during the glass moulding operation or after the glass moulding operation, preferably at the end of all the steps of the fabricating method described above. As seven transparent electrodes can be made, seven thinned portions 8 have to be made in the thickness of the glass, by moulding or milling, and with a slightly greater diameter to the diameter of each electrode or of slightly larger dimensions if the shape of each electrode is not circular.

FIG. 6 shows a partial cross-section of a watch 10, which includes a capacitive touch glass 1 according to the second embodiment.

The wristwatch 10 shown includes, in a known manner, a case, which is formed of a middle part 13 closed on the bottom part thereof by a back cover 15 and on the top part thereof by a glass 1 that delimits a compartment 17. Compartment 17 can house a timepiece movement 18, schematically shown, for the display of time data on a dial 12 by means of hands 16. A bezel 14 may also be provided on middle part 13, which covers part of the glass so as to conceal contact zone 6 of the capacitive touch glass 1.

It can also be seen that watch glass 1 includes transparent electrodes 2 integrated in the plastic material 5 of the glass. Said electrodes 2 are each connected by conductive paths 4 to external contact terminals 6 of a contact zone located close to the edge of the glass. As previously indicated, the electrodes, conductive paths and contact terminals are made in a known manner on an insulating film 3, by structuring a transparent conductive oxide, such as indium and tin oxide (ITO) prior to the moulding operation. Electrodes 2 and conductive paths 4 can be made practically invisible by depositing dielectric compensation layers (not shown) in the spaces between said electrodes 2 and paths 4, as described, for example, in EP Patent No. 1 457 865.

Contact terminals 6 of the glass, which connect transparent electrodes 2 via the conductive paths, are connected directly across a Zebra connector 19, which passes through dial 12. This Zebra connector 19 is secured to a printed circuit board 11, placed on the back of the dial. Connector 19 is connected to an integrated circuit (not shown) that includes the circuit for processing actions on the capacitive touch keys, which is well known.

It is to be noted that wristwatch 10 can be fitted with another embodiment of capacitive touch glass 1, obtained via the fabricating method. One could also envisage integrating at least one decorative layer in the plastic material of the glass as shown in FIG. 4, while keeping the glass with contact terminals 6 uncovered as shown in FIGS. 2 and 3. Moreover, in addition to the decorative layer, the glass could also be thinned locally on the contact surface side, directly above the transparent electrodes, as indicated with reference to FIG. 5.

From the description that has just been given, several variants of the method of fabricating a capacitive touch glass, and of the glass thereby obtained can be devised by those skilled in the art, without departing from the scope of the invention defined by the claims. The transparent electrodes could be placed at mid-height in the thickness of the glass on a top surface of the insulating film opposite the surface of the glass for contact with a user's finger. We could have envisaged making the transparent electrodes in apertures made in the insulating film support so as to limit the thickness of that assembly prior to moulding the film in a plastic material. We could also have envisaged entirely coating the insulating film with the electrodes, conductive paths and contact terminals in a plastic material, then milling one part of the glass near the external contact terminals in order to reveal them. The plastic substance used to form the glass with integrated capacitive touch keys can also be semi-transparent and coloured. The insulating film could include several sets of electrodes, conductive paths and contact terminals so as to form several glasses at the same time in a mould with several compartments.

What is claimed is:

1. A method of fabricating a transparent or semi-transparent element with capacitive touch keys for a portable electronic instrument, wherein it includes steps consisting in:
placing an insulating film, on which are formed transparent electrodes forming capacitive touch keys, transparent conductive paths, each connected to a respective electrode, and external contact terminals, each connected via the conductive paths to the corresponding transparent electrodes, in a transparent or semi-transparent plastic substance in liquid form inside a mould, and
solidifying, inside the mould, the liquid plastic substance, which coats at least part of the film that includes the electrodes, the conductive paths and at least part of the external contact terminals of said film, so as to obtain the transparent or semi-transparent element with capacitive touch keys integrated within said solidified plastic substance of the transparent or semi-transparent element, to improve the sensitivity of the integrated capacitive touch keys, which is inversely proportional to the distance between the electrodes and the contact surface of the transparent or semi-transparent element.

2. The method of fabricating a transparent or semi-transparent element according to claim 1, wherein the insulating film with the electrodes, the conductive paths and the external contact terminals are first of all arranged inside the mould, wherein the liquid plastic substance is then introduced through at least one aperture in the mould, whose inner surface matches the general shape of the transparent or semi-transparent element to be obtained, so as to place at least one part of the film in said liquid plastic substance, and wherein once the mould has been filled with the liquid plastic substance, said liquid plastic substance is solidified to obtain the transparent or semi-transparent element with capacitive touch keys integrated within said solidified plastic substance of the transparent or semi-transparent element.

3. The method of fabricating a transparent or semi-transparent element according to claim 1, wherein the insulating film with the electrodes, the conductive paths and the external contact terminals are first of all arranged inside the mould, wherein a plastic substance in powder form is then introduced through at least one aperture in the mould to fill said mould, wherein the mould is heated to liquefy said plastic substance, which occupies the entire inner volume of the mould, so as to place at least one part of the film in said liquid plastic substance, and wherein said liquid plastic substance is solidified in order to obtain the transparent or semi-transparent element with capacitive touch keys integrated within said solidified plastic substance of the transparent or semi-transparent element upon removal from the mould.

4. The method of fabricating a transparent or semi-transparent element according to claim 1, wherein by placing the transparent insulating film with the transparent electrodes, the transparent conductive paths and the external contact terminals in the mould, which has two parts, at least two portions of the insulating film are clamped by the two parts of the mould in the closed position to hold the film in a determined position inside the mould prior to introducing a liquid or powder plastic substance through at least one aperture in the mould.

5. The method of fabricating a transparent or semi-transparent element according to claim 4, wherein the portions of the film (3) that are not coated by the solidified plastic substance in the mould are cut out outside the mould giving access to the external contact terminals on the lateral surface of the transparent or semi-transparent element.

6. The method of fabricating a transparent or semi-transparent element according to claim 5, wherein upon removal from the mould, and after the non-coated portions of film have been cut out, conductive portions are made that are complementary to the external contact terminals, said complementary portions extending in part over the lateral surface of the transparent or semi-transparent element.

7. The method of fabricating a transparent or semi-transparent element according to claim 4, wherein one of the portions of the flexible film, which are clamped by the two parts of the mould in the closed position, carries all of the external contact terminals and part of the conductive paths, and wherein the liquid plastic substance is solidified inside the mould without coating the portion of flexible film that carries said contact terminals, so as to obtain a transparent or semi-transparent element with one part of the flexible insulating film with the non-coated contact terminals opening out from the lateral surface of the transparent or semi-transparent element.

8. The method of fabricating a transparent or semi-transparent element according to claim 1, wherein the film is placed inside the mould such that, upon removal from the mould, at least one bottom face of the external contact terminals at the edge of the transparent or semi-transparent element and part of the conductive paths are not coated by the solidified plastic substance of the transparent or semi-transparent element.

9. The method of fabricating a transparent or semi-transparent element according to claim 1, wherein initially, a transparent conductive layer of indium and tin oxide is deposited on one surface of the insulating film, and wherein a selective chemical etch is performed on said oxide layer to obtain the transparent electrodes, the transparent conductive paths and the external contact terminals, before the film is placed in the liquid substance in the mould.

10. The method of fabricating a transparent or semi-transparent element according to claim 9, wherein at least one decorative layer is made on one face of the film, partly above the electrodes, conductive paths and contact terminals, relative to a top surface of the transparent or semi-transparent element that comes into contact with a user's finger, wherein the film is then placed in the liquid substance inside the mould, and wherein the liquid substance is solidified inside the mould to obtain the transparent or semi-transparent element with capacitive touch keys and a decorative layer integrated within the solidified liquid substance, the decorative layer arranged between the surface of the film carrying the electrodes, the conductive paths and the contact terminals, and the contact surface of the transparent or semi-transparent element, so that at least the external contact terminals arranged at the edge of the transparent or semi-transparent element are concealed.

11. The method of fabricating a transparent or semi-transparent element according to claim 1, wherein the inner surface of the mould is formed such that, after the operation of solidifying the plastic substance over at least one part of the film, thinned portions are made in the thickness of the transparent or semi-transparent element from the contact surface above the transparent electrodes.

12. The portable electronic instrument including a transparent or semi-transparent element with capacitive touch keys obtained via the fabricating method according to claim 1, and a processing circuit, which is connected, via a connector, to the external contact terminals of the transparent or semi-transparent element.
